(19) United States
(12) Patent Application Publication
(10) Pub. No.: US 2010/0158712 A1
(43) Pub. Date: Jun. 24, 2010

(54) COMPRESSOR WITH DUAL OUTBOARD SUPPORT BEARINGS

(75) Inventors: Michael Hartl, Unterhaching (DE); Stefan Schneider, Munchen (DE); Bill McCurdy, Adams, NY (US)

Correspondence Address: BARNES & THORNBURG LLP, 750-17TH STREET NW, SUITE 900, WASHINGTON, DC, 20006-4675, US

(73) Assignee: New York Air Brake Corporation, Watertown, NY (US)

(21) Appl. No.: 12/343,041

(22) Filed: Dec. 23, 2008

(51) Int. Cl. F04B 17/00; F16C 19/00

(52) U.S. Cl. 417/321; 384/91

(57) ABSTRACT

A compressor includes a motor having a rotor mounted to a free end of a crank shaft and a stator in a motor housing, and a bearing assembly supporting the crank shaft on the crank shaft housing adjacent the motor housing. The bearing assembly includes a bearing housing mounted to the crank shaft housing and including a bore; and a pair of spaced bearings mounted in the bore of the bearing housing and receiving the crank shaft. The space between the bearings is selected to allow the free end of the crank shaft to deform in synchronization with the movement of the stator and maintain a gap between the rotor and stator over the operating range of the motor.

### BACKGROUND AND SUMMARY OF THE DISCLOSURE

The present disclosure is directed generally to compressors and more specifically to compressors where the stator of the motor is supported on the end of the crank shaft such that the motor does not have its own bearing.

In freight trains, especially in the USA and other countries wherein the American Association of Railroads AAR regulations very often applied, direct driven air compressors, meaning the rotor of the electric motor is directly pressed onto the compressor's crank shaft, are quite common. This construction concentrates the mass of the rotor at the free end of the crank shaft. This leads to relatively low eigen frequencies and leads together with the elastic deformation of the crank shaft to gyroscopic effects and hence to an even further reduction of the eigen frequencies. Thermal effects worsen this problem.

The air compressors in diesel locomotives are driven over a wide rotational speed range (400 to 1200 rpm). Different speeds are realized with pole-changeable electric motors. All known designs with these bearing-free rotors suffer from the rotor rubbing on the stator especially at high ambient temperature. As a result of the rubbing, additional heating up of the rotor occurs.

Different strategies have been followed to avoid the motor rubs. See for example U.S. Pat. No. 6,659,739 B2; U.S. Pat. No. 6,447,267 B1; U.S. Pat. No. 6,376,950 B1′; U.S. Pat. No. 6,364,635 B1; U.S. Pat. No. 6,609,899 B1; and U.S. Pat. No. 6,599,103 B2. All of these approaches link the motor rubbing problem solely to the motor. Additional bearings at the free-end of the crank shaft or within the rotor reduce the deformation of the crank shaft to a minimum. All these approaches require modifications of the electric motor. Because of the large quantity of motors in service, none of these solutions was successful so far as they require significant modifications of the motor.

A goal of the present disclosure is an oil free piston compressor, especially for railway applications, where the deformation of the crank shaft resulting from the working process of the compressor is minimized and where the crank shaft and housing are tuned such that the air gap between rotor and stator remain constant. By doing so motor rubbing, contact between the rotor and stator, can be avoided. Also, a construction of direct driven air compressors is without any modifications of the electric unit.

The present compressor has pistons connected to a crank shaft in a crank shaft housing, a motor having a rotor mounted to a free end of the crank shaft and a stator in a motor housing, a bearing assembly supporting the crank shaft on the crank shaft housing adjacent the motor housing. The bearing assembly includes a bearing housing mounted to the crank shaft housing and including a bore; and a pair of spaced bearings mounted in the bore of the bearing housing and receiving the crank shaft. The space between the bearings is selected to allow the free end of the crank shaft to deform in synchronization with the movement of the stator and maintain a gap between the rotor and stator over the operating range of the motor.

The bearing assembly is spaced from the rotor along the crank shaft. One of the bearings maybe in the crank shaft housing and another of the bearings being in the motor housing. At least one of the bearings is in the motor housing. The space between the bearings is no greater than about seventy millimeters.

The motor housing may be mounted directly to the bearing assembly or the crank shaft housing. The bearing housing may have a radial flange with apertures through which fasteners mount the bearing housing to the crank shaft housing. The bearing housing may have a shoulder in the bore and formed with a first face of the flange and ribs extend from a second face of the flange.

One of the bearings closest to the pistons is a locating bearing and another of the bearings closest to the motor is a non-locating bearing. One of the bearings closest to the motor is a non-locating bearing in an axial direction.

The present bearing assembly is for supporting a crank shaft on a crank shaft housing of a compressor adjacent a motor housing. The bearing assembly includes a bearing housing to be mounted to the crank shaft housing and a bore; and a pair of spaced bearings mounted in the bore of the bearing housing and for receiving the crank shaft. The space between the bearings is selected to allow the free end of the crank shaft, on which a rotor of the motor is mounted, to deform in synchronization with the movement of a stator of the motor and maintain a gap between the rotor and stator over the operating range of the motor.

These and other aspects of the present disclosure will become apparent from the following detailed description of the disclosure, when considered in conjunction with accompanying drawings.

### BRIEF DESCRIPTION OF THE DRAWINGS

FIG. 1 is a cross-sectional view of a compressor incorporating a dual bearing according to the present disclosure.

FIG. 2 is an enlarged cross-sectional view of the dual outboard bearing of FIG. 1.

FIG. 3 is an enlarged cross-sectional view of a single bearing of the prior art.

FIG. 4 are graphs of radial displacement as a function of rotational speed of the tip of the crank shaft for a six pole motor on the compressor with a single and a dual bearings.

FIG. 5 are graphs of radial displacement as a function of rotational speed of the tip of the crank shaft for a twelve pole motor on the compressor with a single and a dual bearings.

### DETAILED DESCRIPTION OF THE PREFERRED EMBODIMENTS

The present bearing assembly and compressor are based on theoretic investigations concerning the deformation of the crank shaft and the compressor housing as well as the speed variations during one revolution of the crank shaft caused by the electrical properties of the motor. The present design does not mainly solve the problem of the motor rubs by reducing the crank shaft deformation as done in the above mentioned patents. Here the deformation of the crank shaft, rotor and stator are synchronized so that the air gap between rotor and stator remains constant. This was achieved by one or more of the use of a paired bearing, a stiffer end shield or bearing housing and the direct fixation of the stator on the end shield. A paired bearing with a small distance between the two bearings along is sufficient to synchronize the motion of the free-end of the crank shaft and thus the rotor and the stator.

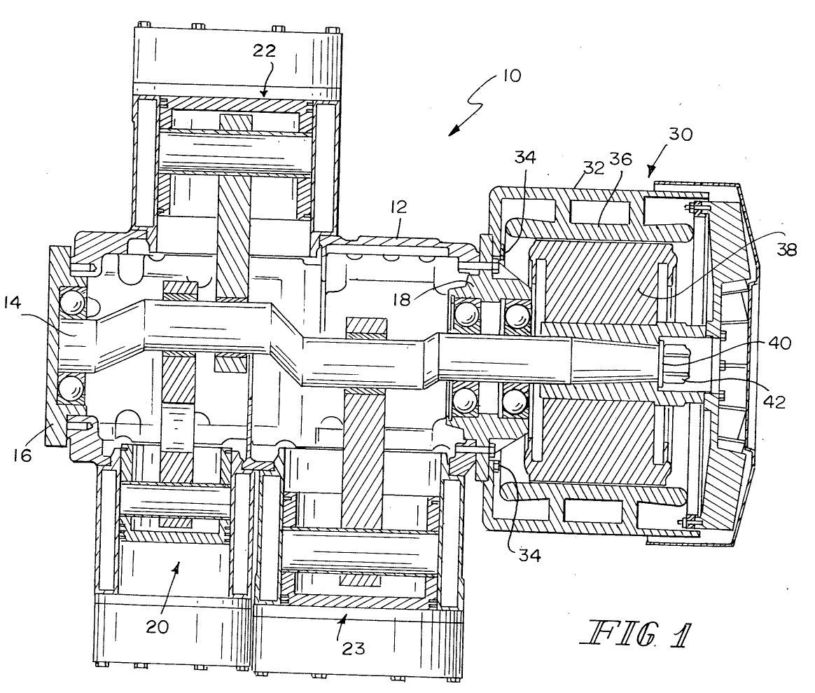

A compressor 10 according to the present disclosure is illustrated in FIG. 1. Compressor 10 includes a crank shaft housing 12 with a crank shaft 14 supported thereto by bearing assemblies 16 and 18 at opposing ends of the crank shaft housing 12. Three pistons 20, 22 and 23 are connected and driven by the crank shaft 14. Although three pistons are shown, a two piston compressor may also be used. The number of pistons is for illustration purposes only.

An electric motor 30 includes a motor housing 32 connected to the crank shaft housing 12 by fasteners 34. The stator 36 is mounted directly to the motor housing 32. A rotor 38 is mounted on the free end 40 of the crank shaft 14 and held thereto by nut 42. As discussed previously, the bearing assembly 18 of the compressor also forms the bearing assembly for the motor which does not have its own independent bearing for the rotation of the rotor 38 relative to the stator 36.

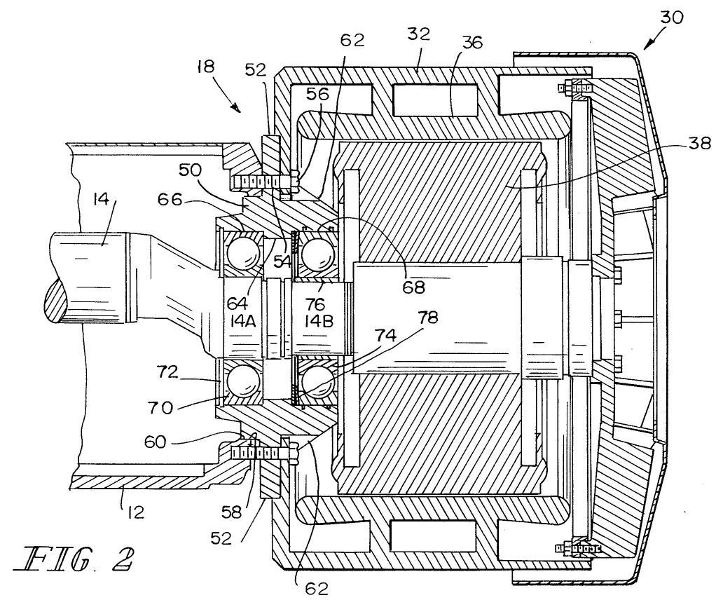

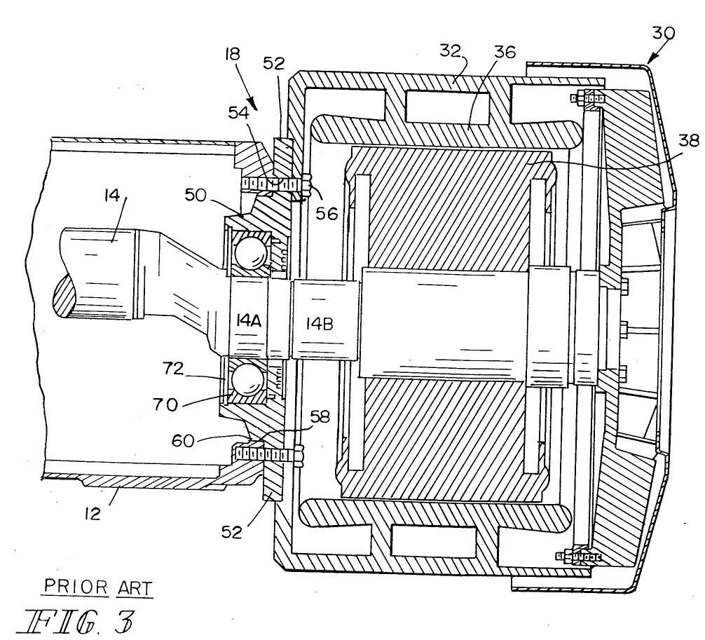

Details of the dual outboard support bearing for the bearing assembly 18 are illustrated in FIG. 2. The prior art single support bearing 18 is illustrated in FIG. 3. Those portions or elements which have the same function and purpose will include the same reference numbers. It should also be noted that the motor 30 is a standard motor and has not been modified to incorporate the dual bearing 18. Thus further details of the motor will not be described. The dual outboard support bearing 18, illustrated in FIG. 2, includes a housing 50 with a flange 52. Apertures 54 are provided in flange 52 and receives a fastener 56 which mounts the bearing assembly 18 to the crank shaft housing 12. A shoulder 58 is formed with a first face of flange 52 and is received in bore 60 of the crank shaft housing 12. The other face of the flange 52 includes a plurality of rib 62 which helps to stiffen the housing structure 50.

The motor housing 32 may be mounted directly to the bearing assembly housing 50 or may be mounted directly to the crank shaft housing 12.

A bore 64 in housing 50 includes a pair of recesses 66 and 68 which receive bearings 70 and 74. The bearing 70 is retained in the recess 66 by snap ring 72. The bearing 74 loosely fits in recess 68. The inner ring of the bearing 74 with bushing 76 is press fitted on the crank shaft 14. Bearing 70 engages crank shaft portion 14A and is considered a locating bearing. This distinguishes from bearing 74 which is a non-locating bearing. The non-locating bearing 74 is bias towards the motor housing 32 by conical washer 78 and allows axial displacement of the crank shaft portion 14B relative to the motor housing 32. This limited motion allows synchronization of the movement on the end 40 of the crank shaft 14 with the rotor 38 thereon with respect to the motor housing 32 and the stator 36 thereon.

The space between the bearings 70 and 74 is selected to allow a synchronization of the movement of the stator and the rotor and maintains a gap between the rotor and the stator over the operating range of the motor. For the particular motor under investigation, the space between the bearings is no greater than about 70 millimeters.

In the illustrated embodiment, one of the bearings, namely bearing 70 is within the crank shaft housing 12, while the other bearing 74 is within the motor housing 32. Locations of the bearings are somewhat symmetrical with respect to the flange 52. Alternatively, both bearings 70 and 74 can be in the motor housing 32 if space allows or both bearings 70 and 74 may be in the crank shaft housing 12. This depends on the particular of the crank shaft 14 with lands 14A and 14B, as well as the housing space of the motor 30.

It should also be noted that the bearing housing 50 and bearing 74 do not encroach on the rotor 38. They are spaced along the rotor 14. This allows using a standard motor without any special adaptation.

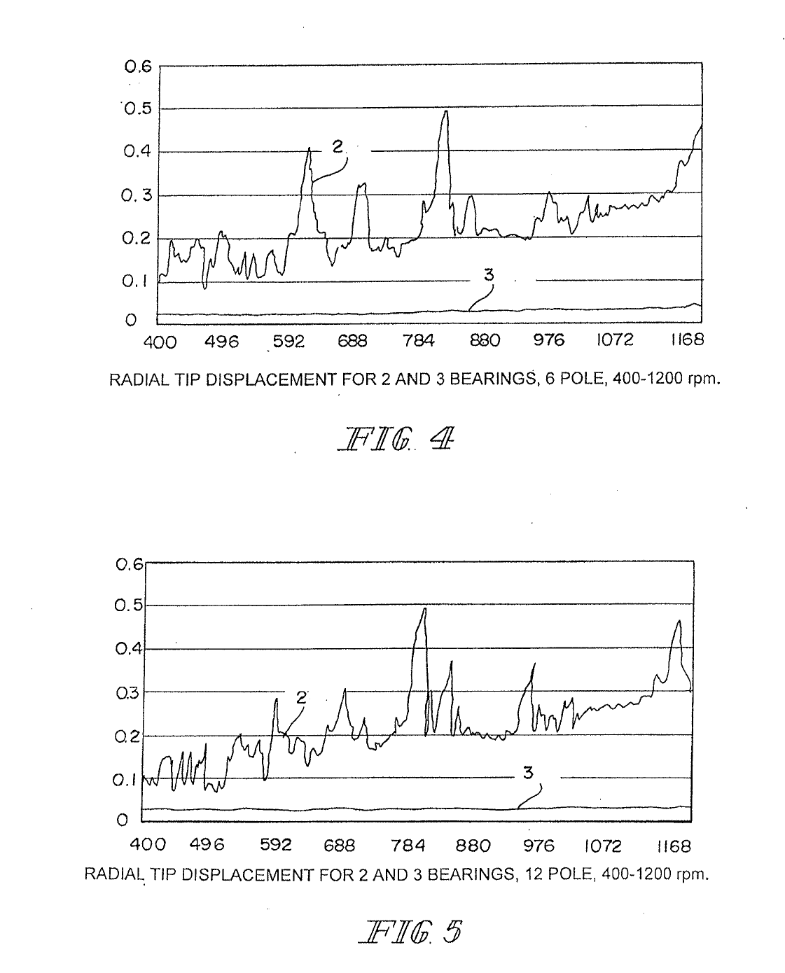

A numerical simulation was performed using the multibody simulation tool SIMPACK. The crank shaft 14, as well as the crank shaft housing 12, were modeled as elastic bodies. The dynamic behavior including driving torque in the various modes of the electric motor was simulated using a P, Q model. A six and twelve pole configurations were investigated. The results are shown in FIG. 4 for the six pole model and in FIG. 5 for the twelve pole model. The two bearing configuration is the standard two bearing configuration of FIG. 3 of the prior art and the three bearing configuration of FIG. 2, which include the first bearing 16 in the count.

A review of the two graphs, which are tip displacement in millimeters compared to the rotational speed of the crank shaft in revolutions per minute, show that the two bearing structure of the prior art over the majority of the scale operates above 0.2 millimeters and even at certain points exceeds 0.3 millimeters. It should be noted that for the structure being investigated, 0.3 millimeters is the normal spacing between the stator and the rotor. The white or gray portion is that of the three bearings which shows very little, if any, peaks above 0.1 millimeter. Thus, the gap between the stator and the rotor is maintained to prevent rubbing over the anticipated operating range of the motor in the 400-1200 revolutions per minute. It should also be noted that the same or similar results are anticipated within the anticipated temperature operating range of the compressor in the range of −40 to 70 degrees centigrade. As would be anticipated, the restriction of the crank shaft in area 14B increases the stress of the load acting on the bearings from 23 Kn to 30 Kn.

Although the present disclosure has been described and illustrated in detail, it is to be clearly understood that this is by way of illustration and example only and is not to be taken by way of limitation. The scope of the present disclosure is to be limited only by the terms of the appended claims.

What is claimed:

1. A compressor having pistons connected to a crank shaft in a crank shaft housing, a motor having a rotor mounted to a free end of the crank shaft and a stator in a motor housing, a bearing assembly supporting the crank shaft on the crank shaft housing adjacent the motor housing, wherein the bearing assembly comprises:
a bearing housing mounted to the crank shaft housing and including a bore;
a pair of spaced bearings mounted in the bore of the bearing housing and receiving the crank shaft;
the space between the bearing being selected to allow the free end of the crank shaft to deform in synchronization with the movement of the stator and maintain a gap between the rotor and stator over the operating range of the motor.

2. The compressor of claim 1, wherein the bearing assembly is spaced from the rotor along the crank shaft.

3. The compressor of claim 1, wherein one of the bearings is in the crank shaft housing and another of the bearing is in the motor housing.

4. The compressor of claim 1, wherein at least one of the bearings is in the motor housing.

5. The compressor of claim 1, wherein the space between the bearings is no greater than about seventy millimeters.

6. The compressor of claim 1, wherein the stator is directly mounted to the motor housing and the motor housing is mounted directly to the bearing assembly.

7. The compressor of claim 1, wherein the stator is directly mounted to the motor housing and the motor housing is mounted directly to the crank shaft housing.

8. The compressor of claim 1, wherein the bearing housing has a radial flange with apertures through which fasteners mount the bearing housing to the crank shaft housing.

9. The compressor of claim 8, wherein the bearing housing includes a shoulder in the bore and formed with a first face of the flange and ribs extending from a second face of the flange.

10. The compressor of claim 1, wherein one of the bearings closest to the pistons is a locating bearing and another of the bearings closest to the motor is a non-locating bearing.

11. The compressor of claim 1, wherein one of the bearings closest to the motor is a non-locating bearing in an axial direction.

12. The compressor of claim 1, wherein the operating range includes speeds of 400 to 1200 revolutions per minute.

13. The compressor of claim 1, wherein operating range of temperatures includes −40 to 70 degrees centigrade.

14. A bearing assembly for supporting a crank shaft on a crank shaft housing of a compressor adjacent a motor housing, wherein the bearing assembly comprises:
a bearing housing to be mounted to the crank shaft housing and including a bore;
a pair of spaced bearings mounted in the bore of the bearing housing and for receiving the crank shaft;
the space between the bearings being selected to allow the free end of the crank shaft on which a rotor of the motor is mount to deform in synchronization with the movement of a stator of the motor and maintain a gap between the rotor and stator over the operating range of the motor.

15. The bearing assembly of claim 14, wherein the space between the bearings is no greater than about seventy millimeters.

16. The bearing assembly of claim 14, wherein the bearing housing has a radial flange with apertures through which fasteners mount the bearing housing to the crank shaft housing.

17. The bearing assembly of claim 16, wherein the bearing housing includes a shoulder to lie in the bore and formed with a first face of the flange and ribs extending from a second face of the flange.

18. The bearing assembly of claim 14, wherein one of the bearings is a locating bearing and another of the bearings is a non-locating bearing.

19. The bearing assembly of claim 1, wherein one of the bearings to be positioned closest to the motor is a non-locating bearing in an axial direction.
